(19) United States
(12) Patent Application Publication
(10) Pub. No.: US 2016/0241796 A1
(43) Pub. Date: Aug. 18, 2016

(54) SYSTEMS AND METHODS FOR ILLUMINATING AND VIEWING OBJECTS

(71) Applicants: Peter S. Curreri, Philipsburg, NJ (US); John K. Wilson, Wilton, NJ (US)

(72) Inventors: Peter S. Curreri, Philipsburg, NJ (US); John K. Wilson, Wilton, NJ (US)

(21) Appl. No.: 14/625,027

(22) Filed: Feb. 18, 2015

(51) Int. Cl. H04N 5/33; F21V 8/00; G02B 6/04; H04N 5/225; H04N 5/232

(52) U.S. Cl. CPC H04N 5/33; H04N 5/2256; H04N 5/23293; H04N 5/23241; G02B 6/04; G02B 6/0008

(57) ABSTRACT

A light source contains a laser having a radiating facet that radiates light with an intrinsic or acquired intensity profile. The light is received by an optical scrambler comprising a bundle of optical fibers having and input surface and an output surface. The input surface formed by input endings of the optical fibers in the bundle, the input endings of the optical fibers having a position in the input surface defined by a first set of coordinates. The output surface formed by output endings of the optical fibers, the output endings of the optical fibers having a position in the output surface defined by a second set of coordinates, the second set of coordinates being a non-affine transformation of the first set of coordinates. The optical scrambler receives the light with the intensity pattern from the laser at the input surface and radiates light from the output surface having a different intensity profile. The light source may illuminate an object with light from the output surface, and further comprise a camera enabled to produce an image of the object and a display connected to the camera to display the image produced by the camera of the object.

### FIELD OF THE INVENTION

This invention relates to systems for illuminating objects and for capturing images of the objects by an image sensor, such as a camera. More specifically, it relates to systems and methods for using laser diodes and scrambled optical fibers for illuminating objects for viewing by a vision apparatus, such as night vision goggles or night vision cameras.

### BACKGROUND OF THE INVENTION

Night vision systems have several military and civilian applications. Night vision systems may be employed in office spaces, commercial sites, and parking lots for remote viewing and security. Alternatively, night vision systems may be employed with goggles to achieve situational awareness in low-light or no-light environments.

Night vision systems may employ various techniques to achieve night vision. One technique is to intensify images of objects using natural sources of light, such as starlight or moonlight, by outputting visible light from the system at a greater intensity than the ambient light entering the system. Thus, the system produces an intensified image that is perceptible by the human eye from a level of light that is below the perceptible threshold.

Some night vision systems may also use active illumination techniques in combination with image intensification techniques to enhance the quality of the images produced by the system. For example, an active infrared night vision system may employ a light source in the infrared spectral range in combination with a CCD or CMOS camera sensitive to those infrared wavelengths. Such night vision systems are useful when covertness is required because the illumination source is restricted to wavelengths of light that are not perceptible to the human eye.

Current active illumination and viewing systems and methods are limited. For example, some applications of active illumination and viewing systems require high definition images. To obtain a high definition image of objects at a significant distance using active illumination, it is essential to use a high powered and efficient light source that is capable of emitting uniform radiation. Currently existing illumination sources are deficient in each of these characteristics. As a result, current night vision systems are not able to provide images with the resolution required for certain civilian and military applications. Furthermore, various active illumination light sources have a size that makes them impractical for use with night vision goggles, and other active illumination light sources are prohibitively expensive.

Thus, there is a need for new and improved systems and methods to achieve improved illumination and viewing of objects to achieve ultra-high resolution images in a cost effective manner.

### SUMMARY OF THE INVENTION

The invention described herein overcomes the deficiencies of using multimode laser diodes as a light source for active illumination with vision systems. Among other things, the present invention provides various structures and methods that can eliminate the appearance of spatial variations in light intensity when using a laser diode as the light source for active illumination with night vision systems. As used herein, the term “light” refers to all electromagnetic radiation, regardless of whether or not that radiation is visible to the human eye. Furthermore, the use of the terms “recording,” “capturing,” and “taking” an image refers to permanently storing the image in some tangible medium of expression or simple use of a device to view an image without permanent storage.

In accordance with one embodiment of the present invention a light source comprises a laser diode and an optical signal scrambler. The laser having a radiating facet that radiates light that intrinsically has, or acquires, a multi-peaked intensity profile. A multi-peaked intensity profile may be described as two or more peaks of light intensity relative to the envelope of measured light intensity. The optical signal scrambler comprises a bundle of optical fibers. An input surface may be formed by the input endings of the optical fibers in the bundle, with the input endings having a position in the input surface defined by a first set of coordinates. An output surface may be formed by the output endings of the optical fibers, the output endings of the optical fibers having a position in the output surface defined by a second set of coordinates. The second set of coordinates being a non-affine transformation of the first set of coordinates. The optical scrambler receives the light with the multi-peaked intensity pattern from the laser at the input surface and radiates light from the output surface that has a single-peak intensity profile. A single-peak intensity profile may be described as a single peak of light intensity relative to the envelope of measured light intensity. (See, e.g., the envelope of measured light intensity 950 for light emitted from an embodiment of the invention 920 in FIG. 10)

In another embodiment of the present invention, the intensity profile of light received by the input surface has two or more peaks of intensity, and the intensity profile of light radiated from the output surface as a single peak of intensity.

In another embodiment of the present invention, one or more of the optical fibers in the bundle may be divided into two or more branches. In some embodiments, the branching of the optical fibers may be located at one or both ends of one or more optical fibers. In other embodiments, the branching may occur in the middle of one or more optical fibers.

In another embodiment of the invention, the multi-mode laser may emit light with a wavelength in the range of 365 nanometers (nm) to 2 micrometers (um). In an alternative embodiment, the multi-mode laser may emit light with an infrared wavelength.

In accordance with another aspect of the present invention, the input surface formed by the input endings of the optical fibers in the bundle may have a rectangular shape. In some embodiments, the output surface formed by the output endings of the optical fibers may have a circular shape. Other shapes are possible for each of the input and output surfaces formed by the input and output endings of the fibers. In one or more embodiments, the invention is adapted to receiving a beam of light having a first shape, and outputting a beam of light having a second shape that is different from the first shape.

Various embodiments of the present invention comprise housings or modules comprising various components. These and other aspects of the invention are discussed further in the specification.

In one embodiment of the present invention, the light source may comprise a housing which encloses the multi-mode laser and the optical scrambler, the housing may comprise an output aperture at the output surface formed by the output endings of the optical fibers. Other embodiments of the present invention may comprise a second housing which encloses a power supply that is electrically coupled to a laser driver. The laser driver may have an output coupled to the laser to provide power to the laser.

In yet other embodiments of the present invention, an object may be illuminated by single-peak light emitted from the laser, and a camera may be enabled to produce an image of the object. A display may be connected to the camera to display the image of the object produced by the camera. In some embodiments of the present invention, the camera may be capable of recording light within a spectrum range from ultraviolet to infrared.

In one or more embodiments, the camera may be connected to the multi-mode laser housing.

Other embodiments of the present invention may include an ambient light sensor connected to a circuit that cuts off power to the multi-mode laser when ambient light is present.

Yet other embodiments of the invention include the camera comprising a light filter that may be switched in when ambient light reaches a particular threshold and switched out when ambient light reaches another threshold. This embodiment of the invention may comprise the filter being switched in when ambient light is above a pre-determined level in the visible spectrum and switched out when ambient light is below the desired intensity in the visible spectrum. Various thresholds for switching the light filter in and out are possible.

In one or more embodiments of the invention, the display connected to the camera to display the image produced by the camera of the object may be goggles that can be worn.

In various embodiments of the present invention, the light source may comprise a motion sensor connected to a circuit that turns on power to the multi-mode laser when motion is detected.

Another aspect of the present invention includes a method for producing an image of an object with a camera, comprising a laser diode emitting light with a multi-peaked intensity profile. An input surface of a bundle of optical fibers receiving the light with the multi-peaked intensity profile, the bundle of optical fibers transmitting to an output surface that arranges the optical fibers in a second arrangement. Illuminating the object with the light from the output surface, the light from the output surface having a single-peak intensity profile when compared to the light transmitted to the input surface by the laser diode. Producing an image based on the single-peak light received by the camera.

In another embodiment of the present invention includes a method for producing an image of an object with a camera, wherein the light used to illuminate the object is infrared light emitted from an infrared laser diode.

Another embodiment of the present invention includes a method for producing an image of an object with a camera, wherein the intensity profile of light received by the input surface has two or more peaks of intensity, and the intensity profile of light radiated from the output surface has a single peak of intensity.

Another embodiment of the present invention includes a method for producing an image of an object with a camera, wherein the produced image is high definition. In other embodiments, the image produced has a resolution of 1920×1080p or higher.

In accordance with one embodiment of the present invention a light source comprises a multi-mode laser diode having a radiating facet. The facet may radiate light that diverges with a first beam intensity profile having a first shape. The invention may also comprise a bundle of optical fibers having an input surface formed by input endings of the optical fibers in the bundle and an output surface formed by output endings of the optical fibers in the bundle. The input surface of the bundle of optical fibers receives the light, and the output surface of the bundle of optical fibers emits the light. The light emitted from the output surface diverges with a second beam intensity profile having a second shape, the second shape being different from the first shape. The input endings of the optical fibers have a position defined by a first set of coordinates relative to the input surface, and the output endings of the optical fibers have a position defined by a second set of coordinates relative to the output surface. A plurality of the output endings may be mixed in the output surface in a non-affine manner relative to the input endings in the input surface.

In another embodiment of the invention, the intensity of the beam profile of light from the multi-mode laser diode is asymmetric around the midpoint of the beam profile and the beam profile of light from the output surface is substantially symmetric around the midpoint of the beam profile.

In another embodiment, the width of the beam profile curve, at 50% maximum relative intensity, along at least one axis crossing the midpoint of the beam profile of light from the output surface, is greater than the width of the beam profile curve, at 50% maximum relative intensity, along at least one axis crossing the midpoint of the beam profile, of light from the multi-mode laser diode.

In another embodiment, the width of the beam profile curve, at 50% maximum relative intensity, along a first axis crossing the midpoint of the beam profile of light from the output surface, is at least 190% greater than the width of the beam profile curve, at 50% maximum relative intensity, along a first axis crossing the midpoint of the beam profile, of light from the multi-mode laser diode.

In another embodiment, the width of the beam profile curve, at 50% maximum relative intensity, along a first axis crossing the midpoint of the beam profile of light from the output surface, is at least 400% greater than the width of the beam profile curve, at 50% maximum relative intensity, along a first axis crossing the midpoint of the beam profile, of light from the multi-mode laser diode.

In another embodiment, the width of the beam profile curve, at 50% maximum relative intensity, along a first axis crossing the midpoint of the beam profile of light from the output surface, is at least 190% greater than the width of the beam profile curve, at 50% maximum relative intensity, along a first axis crossing the midpoint of the beam profile, of light from the multi-mode laser diode; and the width of the beam profile curve, at 50% maximum relative intensity, along a second axis crossing the midpoint of the beam profile of light from the output surface, is at least 400% greater than the width of the beam profile curve, at 50% maximum relative intensity, along a second axis crossing the midpoint of the beam profile, of light from the multi-mode laser diode.

In another embodiment, the first beam intensity profile has a curve along a first axis crossing the midpoint of the beam intensity profile, the curve bounded at 13.5% maximum light intensity, with a convex envelope differential having a first value. The second beam intensity profile has a curve along a second axis crossing the midpoint of the beam intensity profile, the curve bounded at 13.5% maximum light intensity, with a convex envelope differential having a second value. The ratio of the first value to the second value is less than 0.8, less than 0.6, or less than 0.1.

In another embodiment of the invention, the optical fibers in the bundle are divided into two or more branches.

In yet other embodiments, the laser emits light with a wavelength in the range of 365 nm to 2 um, emits light with an infrared wavelength, emits lights with a visible wavelength, or emits light with an ultraviolet wavelength.

Another aspect of the present invention may comprise an input surface having a rectangular shape and an output surface having a circular shape. The input surface being able to receive a first beam with a profile having a non-circular shape and the output surface being able to emit a second beam with a profile having a circular shape.

In yet another aspect of the present invention, the light source may comprise a housing which encloses the laser and the optical scrambler, the housing comprising an output aperture at the output surface. One or more embodiments may further comprise a second housing which encloses a power supply electrically coupled to a laser driver, wherein the laser driver has an output coupled to the multi-mode laser to provide power to the multimode laser.

Other embodiments may comprise a light source wherein an object is illuminated by light from output surface, further comprising a camera enabled to produce an image of the object and a display connected to the camera to display the image produced by the camera of the object. The camera may be capable of recording light within a spectrum range from ultraviolet to infrared. The camera may be connected to the multi-mode laser housing.

Some embodiments of the invention may comprise an ambient light sensor connected to a circuit that cuts off power to the multi-mode laser when ambient light is present. The camera may further comprising a light filter that is switched in when the amount of visible ambient light is above a pre-determined threshold set by a user and switched out when the amount of visible ambient light is below the pre-determined threshold set by the user.

Another embodiment of the present invention may comprise a display that is goggles that can be worn.

Another aspect of the present invention is a method for producing an image of an object with a camera comprising the following. A multi-mode laser diode emitting light with a first beam intensity profile having a first shape and an input surface of a bundle of optical fibers receiving the light with the first beam profile having a first shape. The bundle of optical fibers transmitting the light to an output surface that arranges the optical fibers in a second arrangement. Illuminating the object with the light from the output surface, the light from the output surface having a second beam intensity profile with a second shape, the second shape being different from the first shape. Producing an image using the light having the second beam profile with the second shape, received by the camera. In some embodiment, the light emitted from the camera is infrared.

Some embodiments of the invention may be directed to a method for producing an image of an object with a camera, wherein the input endings of the optical fibers have a position in the input surface defined by a first set of coordinates, and the output endings of the optical fibers have a position in the output surface defined by a second set of coordinates, the second set of coordinates being a non-affine transformation of the first set of coordinates.

One or more embodiment may be directed to a method for producing an image of an object with a camera, wherein the intensity of the beam profile of light from the multi-mode laser diode is asymmetric around the midpoint of the beam profile and the beam profile of light from the output surface is substantially symmetric around the midpoint of the beam profile.

In some embodiments directed to a method for producing an image of an object with a camera, the width of the beam profile curve, at 50% maximum relative intensity, along at least one axis crossing the midpoint of the beam profile of light from the output surface, is greater than the width of the beam profile curve, at 50% maximum relative intensity, along at least one axis crossing the midpoint of the beam profile, of light from the multi-mode laser diode. In some embodiments, the width of the beam profile curve, at 50% maximum relative intensity, along a first axis crossing the midpoint of the beam profile of light from the output surface, is at least 190% greater than the width of the beam profile curve, at 50% maximum relative intensity, along a first axis crossing the midpoint of the beam profile, of light from the multi-mode laser diode. In yet other embodiments, the width of the beam profile curve, at 50% maximum relative intensity, along a first axis crossing the midpoint of the beam profile of light from the output surface, is at least 400% greater than the width of the beam profile curve, at 50% maximum relative intensity, along a first axis crossing the midpoint of the beam profile, of light from the multi-mode laser diode. In yet other embodiments, the width of the beam profile curve, at 50% maximum relative intensity, along a second axis crossing the midpoint of the beam profile of light from the output surface, is at least 400% greater than the width of the beam profile curve, at 50% maximum relative intensity, along a second axis crossing the midpoint of the beam profile, of light from the multi-mode laser diode.

In one or more embodiments of the present invention directed to a method for producing an image of an object with a camera, the first beam intensity profile has a curve along a first axis crossing the midpoint of the beam intensity profile, the curve bounded at 13.5% maximum light intensity, with a convex envelope differential having a first value. The second beam intensity profile having a curve along a second axis crossing the midpoint of the beam intensity profile, the curve bounded at 13.5% maximum light intensity, with a convex envelope differential having a second value. Wherein the ratio of the first value to the second value is less than 0.8, less than 0.6, or less than 0.1.

In one or more embodiments of the present invention directed to a method for producing an image of an object with a camera, the produced image is high definition. In yet other embodiments, the produced image has a resolution of 1920×1080p or higher.

### BRIEF DESCRIPTION OF THE DRAWINGS

FIG. 1 illustrates an illumination and vision system in accordance with an aspect of the present invention.

FIG. 2A illustrates a light source in accordance with an aspect of the present invention.

FIG. 2B illustrates a light source in accordance with another aspect of the present invention utilizing multiple laser sources.

FIG. 3 illustrates a power supply and laser driver in accordance with an aspect of the present invention.

FIGS. 4 and 5 further illustrates a light source in accordance with an aspect of the present invention.

FIG. 6 further illustrates a fiber optic cable and connectors used in accordance with an aspect of the present invention.

FIG. 7 illustrates a non-affine transformation of the fiber optic cable in accordance with an aspect of the present invention

FIG. 8 illustrates a non-affine transformation of the fiber optic cable in accordance with an aspect of the present invention.

FIG. 9 illustrate a beam intensity profile of raw light emitted from a laser diode and homogenized light emitted from the light source according to one embodiment of the present invention.

FIG. 10 illustrates a beam intensity profile of raw light emitted from a laser diode and homogenized light emitted from the light source according to one embodiment of the present invention.

FIG. 11 provides a three dimensional illustration of a beam intensity profile of raw light emitted from a laser diode and homogenized light emitted from the light source according to one embodiment of the present invention.

FIG. 12 illustrates an aspect of the present invention directed to a training a user.

### DETAILED DESCRIPTION

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages, construction, and use of the invention. In the various views of the drawings, like reference characters designate like or similar parts.

This invention involves imaging systems using a laser diode light source. In various embodiments, the system incorporates unique methods to propagate and view visible and/or non-visible light in unique configurations without cross talk interference with other security viewing technologies. These systems may be vehicle based, installed as permanent or semi-permanent systems in a building, or portable with a back pack. In one or more embodiments, the system may comprise a camera, a light-source illuminator, and an AC/DC power supply or a battery pack. Alternatively, various embodiments may employ goggles for display of images. Furthermore, one or more embodiments of the invention may employ a dual use camera that is capable of switching from visible to non-visible response for use in day or night. Various recorders may also be used in various embodiments of the invention, as well as various power supplies. Embodiments of the present imaging system may produce ultra-high resolution images that far exceed the pixelated imaging afforded with current imaging systems.

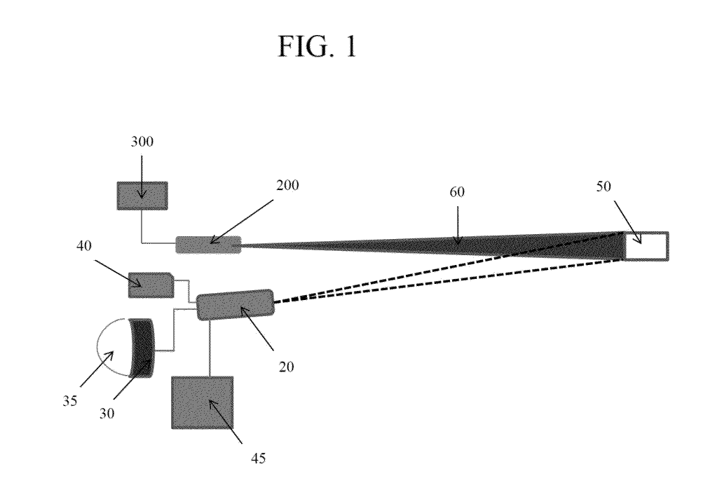

FIG. 1 illustrates one possible configuration of an imaging system in accordance with an aspect of the present invention. An light source 200 radiates light 60 onto an object 50. The illuminated object 50 may then be viewed by a camera 20 using the light 60 radiated from the light source 200. The object 50 may be at a distance from the illuminator 20 greater than 0.1 m, 0.5 m, 1 m, 5 m, 10 m, or 50 m. The light source 200 may be operatively connected to a power supply 300 that is both capable of supplying power to the light source 200 and controlling when the light source 200 is active or non-active. The camera 20 may be operatively connected to a recording device 40 to record the image of the object 50 captured by the camera 20. As seen in FIG. 1, in some embodiments, goggles 30 are operatively connected to the camera 20 for displaying an image of the object 50 to a user 35. In other embodiments, the image of the object 50 captured by the camera 20 is sent to an operatively connected display 45 that is capable of displaying an image of the object 50 captured by the camera 20. In various embodiments, one or more of the camera 20, recorder 40, goggles 30, display 45, light source 200, or power supply 300 may be operatively connected to one another by means of wired or wireless connection. Furthermore, in one or more embodiments, one or more of the camera 20, recorder 40, goggles 30, display 45, light source 200, or power supply 300 may be together in a single housing.

The camera used in one or more embodiments of the present invention may be capable of viewing light, such as visible and infrared energy (e.g. approximately 1064 nm), with frame rates of greater than or equal to approximately 30 Hz with high definition resolution. In some embodiments of the invention, the camera may capture light with frame great of greater than or equal to 60 Hz with high definition resolution. In one or more embodiments, the camera may be capable of capturing light for production of images at a resolution of 1920×1080p or higher. In various embodiments, the camera's frame rate and resolution may be tied to each other, i.e., the frame rate may depend, to some extent, on the resolution, and vice versa. The camera may also be capable of switching between ultraviolet, visible, and infrared wavelengths, and may also include a compensation filter that auto indexes to compensate for energy shift photopic vs scotopic properties. In some embodiments, the camera may switch out a compensation filter under one type of ambient light conditions, and switch in a compensation filter under different ambient light conditions. The camera may also be available in multiple configurations with options that include DC (direct current), POE (power over Ethernet), Flash storage, NTSC (U.S. format developed by the National Television Committee) or PAL (Phase Altering Line used by most of Europe), motion alarms, among others.

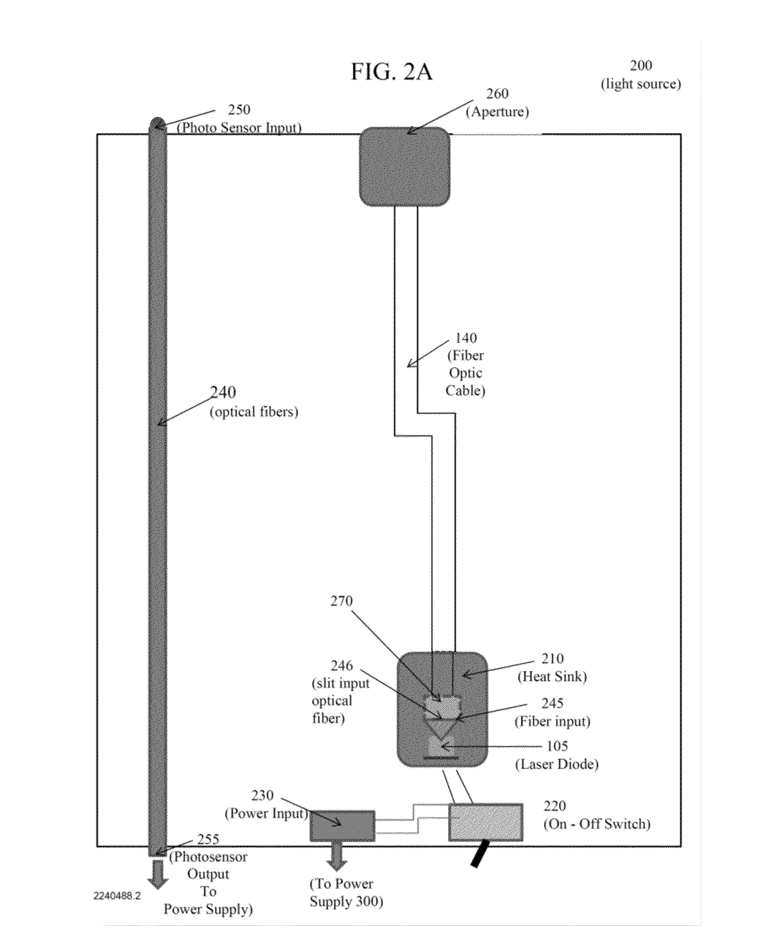

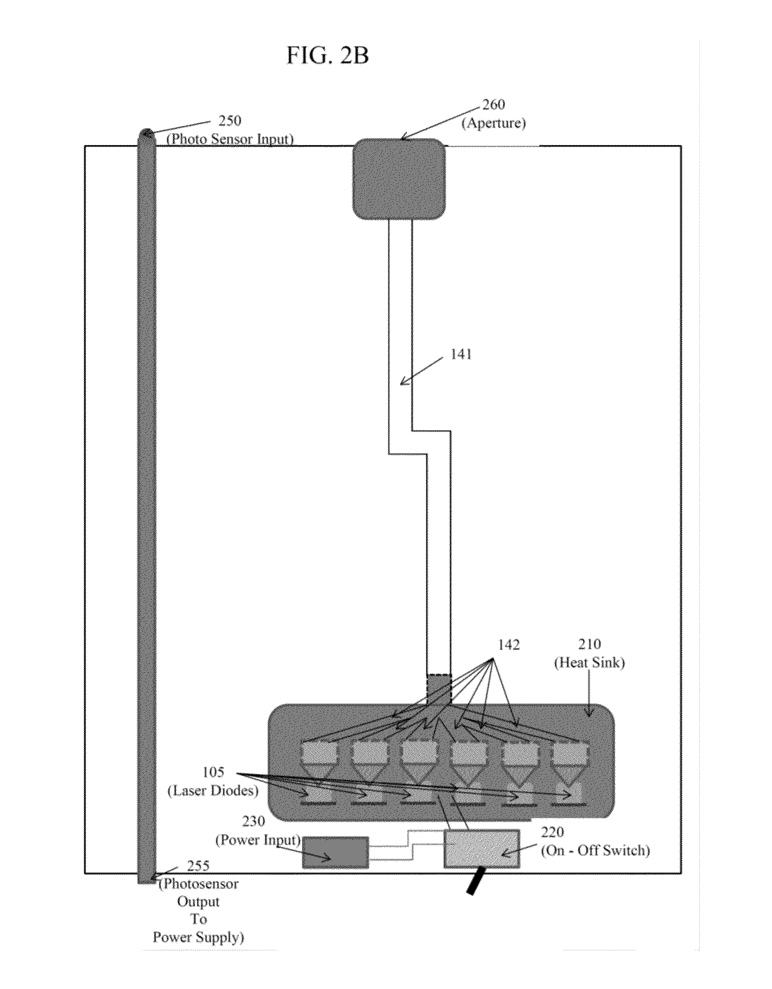

Embodiments of the present invention involve using a light source for illumination of objects. In some embodiments, the light source may comprise one or more laser diodes connected to a heat sink, a switch for controlling power input to the laser diode, an aperture through which light is radiated from the light source and an input capable of receiving ambient light. FIG. 2A illustrates one possible configuration of the light source in accordance with an aspect of the present invention. As seen in FIG. 2A, some embodiments of the light source may comprise a laser diode 105 connected to a heat sink 210. Light radiated from the laser diode 105 may be received by the input 245 of optical fibers 140. In some embodiments, the input 245 of the optical fibers 140 may be operatively connected to a cap 270 having an input slit 246, through which light from the laser diode 105 may be received. The light received by the optical fibers 140 may be transmitted to an aperture 260 and subsequently emitted out of the light source housing 200. The input slit 246 may be adapted to receive the shape of light emitted from the laser diode 105. In one or more embodiments, the power used to power the laser diode 105 is transmitted to the laser diode 105 from a power input 230. The power input 230 may receive power from the power supply 300. In some embodiments, the power transmitted to the laser diode 105 from the power input 230 is controlled by an ON/OFF switch 220 that is operatively connected to the power input 230. In one or more embodiments, the light source 200 comprises a photo sensor input 250 that is operatively connected to photo sensor fibers 240. The photo sensor input may be capable of receiving ambient light, and transmitting that ambient light through the photo sensor fibers 240 to a photo sensor output 255. The photo sensor output 255 may be operatively connected to the power supply 300. In alternative embodiments, the photo sensor fibers 240 may be operatively connected to a photo sensor circuit that is connected to the power supply 300 and configured to turn off power to the laser diode 105. In one or more embodiments, the photo sensor circuit may be housed in the light source 200 or in the power supply 300. In some embodiments, the optical fibers 140 may be placed in a substantially straight path from the slit input 270 to the aperture 260. In other embodiments, the optical fibers 140 may take a circuitous route from the slit input 270 to the aperture 260, such as a curved or coiled path. Similarly, the photo sensor fibers 240 may take a substantially direct route or circuitous route from the photo sensor input 250 to the photo sensor output 255.

FIG. 2B illustrates the system as described in FIG. 2A but with multiple lasers. As seen in FIG. 2B, one or more heat sinks 210 may be connected to one or more laser diodes 105. The one or more laser diodes 105 may emit light that is received by the fiber input 245 through a slit input 246. Multiple fiber optic bundles 142, each receiving light emitted from the laser diode 105, may be combined to form a larger aggregate fiber optic bundle 141, which emits light through an aperture 260.

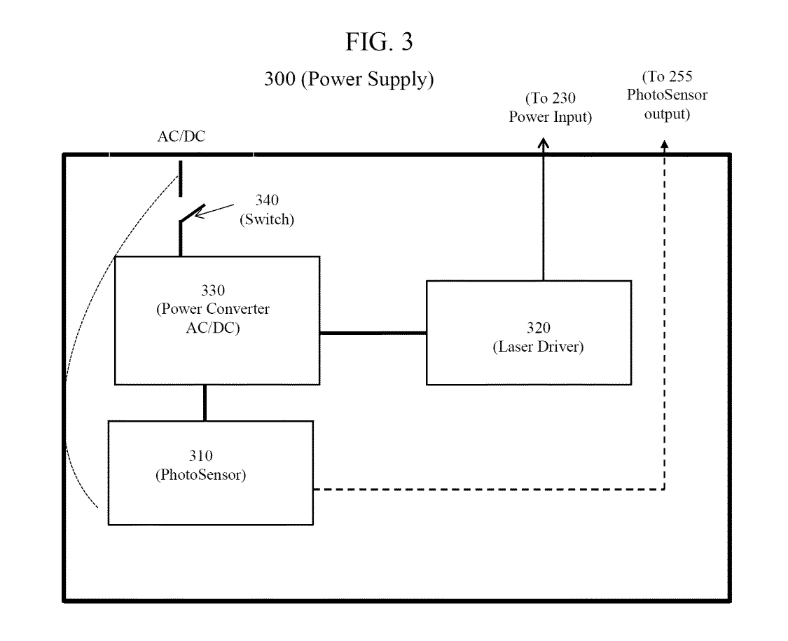

FIG. 3 illustrates one possible configuration for the power supply 300, in accordance with an aspect of the present invention, that provides power to the laser diode 105. In one or more embodiments, a power converter 330 receives AC or DC power from an external power source and converts the electric energy from one form to another, e.g., converting between AC and DC power, converting the voltage or frequency of the power, or some combination of these. In one or more embodiments, the power converter 330 comprises one or more of a class of electrical machinery that is capable of converting one frequency of alternating current into another frequency. In some embodiments, the power supply 300 is a compact AC input, DC output power supply. Such power converters 330 are well known.

In alternative embodiments of the present invention, a battery pack may be used to provide power to all or some parts of the invention. For example, a battery pack may supply energy to the camera 20, the illuminator 200, or both.

In FIG. 3, the power converter 330 is operatively connected to a laser driver 320 that is used to provide power to the laser diode 105. In some embodiments, the laser driver may produce a constant regulated voltage or produce a constant current driven through the laser diode 105. Laser drivers 320 are well known in the art. In one or more embodiments, the laser driver 320 comprised of components to regulate current and voltage suitable to power a laser diode. A switch 340 may be operatively connected to the laser driver 320 directly or via the power converter 330. The switch 340 may be controlled by the photo sensor 310.

In some embodiments of the present invention, one or more components of the camera, recorder, display, light source or power supply may be controlled by a motion detector which is operatively connected to the camera sensor and electronics. For example, in some embodiments, the motion detector may activate the light source upon the detection of movement and deactivate the light source in the absence of detected movement. In other embodiments, the motion sensor may activate the camera upon the detection of movement and deactivate the camera in the absence of detected movement.

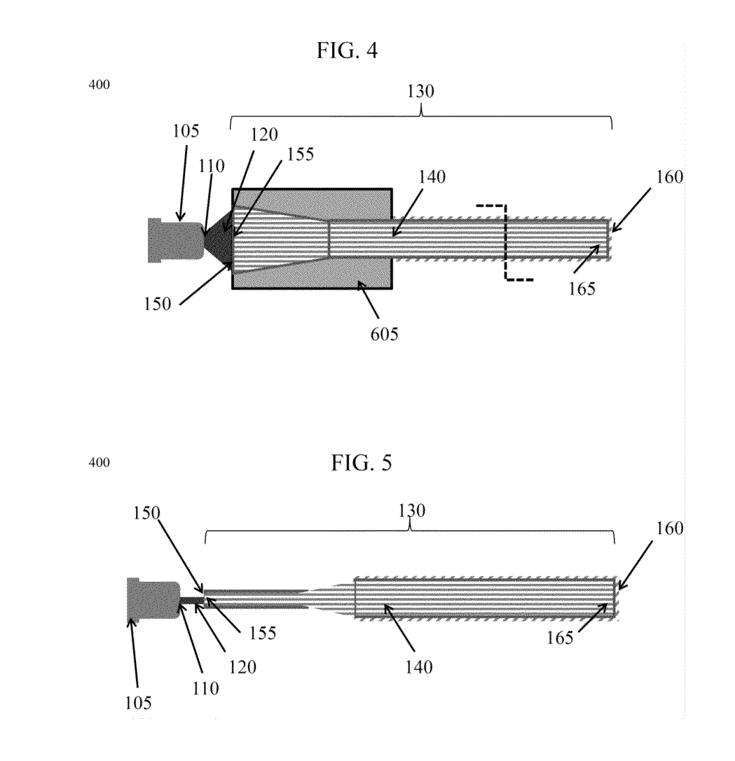

Embodiments of this invention involve using a laser diode and an optical scrambler as a light source for illumination. FIGS. 4 and 5 show an exemplary and non-limiting example of one embodiment of the illuminator 400 of the invention. FIGS. 4 and 5 illustrate a cross sectional top view and cross sectional side view, respectively, of the multi-mode laser 105 and optical signal scrambler 130 according to one embodiment of the present invention. A multi-mode laser 105 emits light 120 from a radiating facet 110. The light 120 is received by an input surface 150 that is formed by the input endings 155 of the optical fibers in the bundle 140. The lines depicting the bundle of optical fibers 140 in FIGS. 4 and 5 are merely representative of the presence of optical fibers; they do not necessarily represent the orientation, dimensions or position of the fibers. The light 120 that is received by the input surface 155 is transmitted via the optical fibers in the bundle 140 to the output endings 165. The light 120 is emitted from the output surface 160 that is formed by the output endings 165 of the optical fibers in the bundle 140.

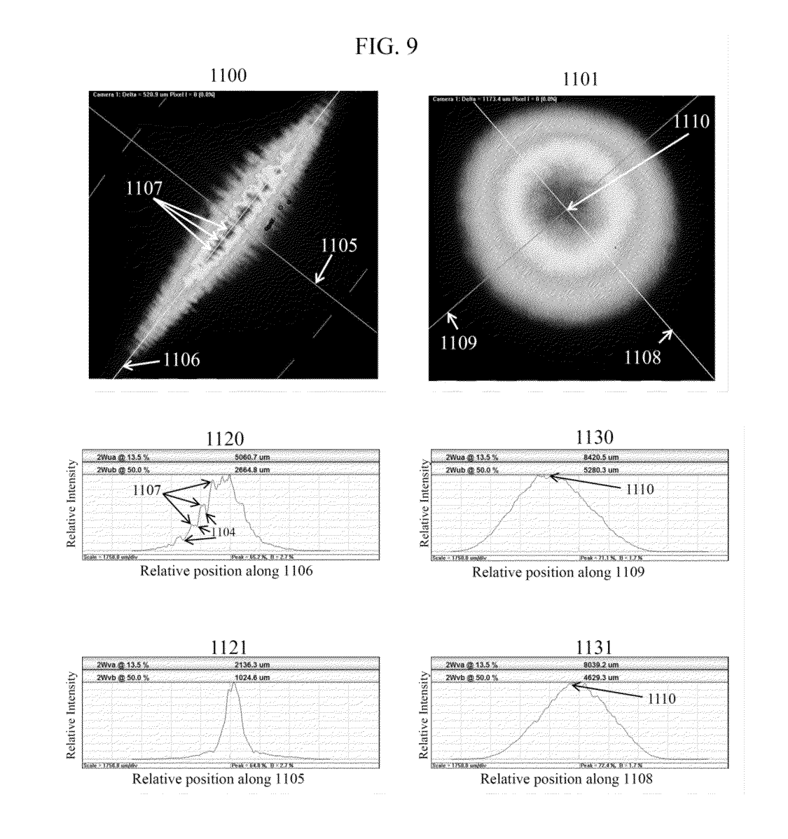

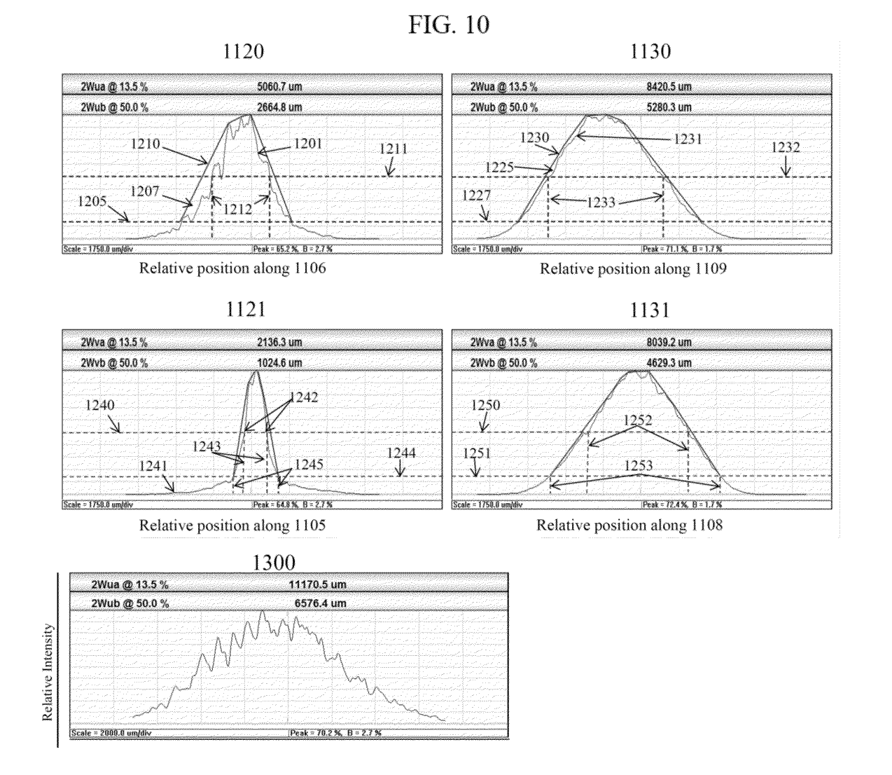

The laser diode of the present invention may radiate light having a fast (short) axis and a slow (long) axis, with light emitted from the facet at a divergence of approximately 38 degrees in the fast axis and 7 degrees in the slow axis or others values as may be present with lasers from various manufacturers. The laser diode radiating light inherently has, or acquires, a non-uniform intensity profile. This non-uniform intensity profile may be described as having a multiple peaks and troughs of intensity along the envelope of measured light. Alternatively, the non-uniform intensity profile may be described as being “banded” having more than one peak of intensity at one or more positions along either diverging axis of the light when the envelope of light is measured. The non-uniform intensity profile may result from using multi-mode laser diode, a multiple emitter laser diode (such as a laser diode array), or any other source or cause of variations in light intensity across an envelope of measured light emitted from a laser diode. Thus, the non-uniform intensity profile along the envelope of measured light may have regular variations in spatial intensity or irregular variations in spatial intensity across any axis of the emitted light. As explained in more detail below, a beam profile of the light emitted from an exemplary multi-mode laser can be seen as the raw beam profile 1100, 1120, and 1121 in FIGS. 9 and 10.

The laser diode used in one or more embodiments of the present invention may be, and preferably is, a multi-mode single laser diode. It can also be a multi-mode laser diode bar, several multi-mode single emitters in an array, single-mode single laser diode, single-mode laser diode bar, several single-mode single emitters in an array, stacked multi-mode laser diodes, or stacked single-mode laser diodes, among others. Some embodiments of the present invention may comprise one or more of those laser diode types. Multi-mode laser diodes are preferred because they are less expensive. However, as described in more detail below, they have problematic output profiles that are controlled with certain aspects of the present invention.

Multiple laser diodes may be used in one or more embodiments of the present invention. In some embodiments there is no practical limit to the number (n) lasers that can be used to increase the energy output of the system if the illumination level proves to be insufficient. See, e.g., multiple laser diodes in FIG. 2B. For example, one or more embodiments of the present invention may employ up to 10 laser diodes, 100 laser diodes, or 1000 laser diodes. Various embodiments may employ greater than 1000 laser diodes. The light emitted from the one or more laser diodes may be received by the input surface of one or more bundles of optical fibers, and may be aggregated at an output surface of one or more bundles of optical fibers.

The light source invention further includes an optical signal scrambler comprising a bundle of optical fibers. The length of the fibers may vary in one or more embodiments, and may be quite short or very long. In some embodiments the length of the optical fibers may be between the length of approximately 5 cm and 1000 cm. In other embodiments, the length of the optical fibers may be longer than 1000 cm. Different optical fiber material types may be used, including but not limited to fused silica, glass, plastic IR materials or reflective tubing. The core diameter of the optical fibers may also vary significantly between one or more embodiments of the invention. In one or more embodiments, the core diameter of the optical fibers may be as small as approximately 8 um or may be as large as approximately 200 um. In some embodiments, the diameter of the optical fibers may be approximately 50 um. In other embodiments of the invention, the bundle of optical fibers may comprise a mixture of fibers having varying diameters. The optical fibers may be multi-mode or single mode according to the fiber diameter. The individual optical fibers may have a cross sectional shape of a circle, square, rectangle, or other shape, and may define a hollow core having a cross sectional shape of a circle, square, rectangle, or other shape. The individual optical fibers may be divided into two or more branches. Thus, in one or more embodiments of an aspect of the present invention, there may be more optical fiber endings in the input surface than in the output surface, or more optical fiber endings in the output surface than in the input surface.

In one or more embodiments of the invention, the fiber bundle may be split into one or more smaller bundles. The one or more smaller bundles may receive light from one or more laser diodes on the input ends. The smaller bundles may be combined at the output ends to form one or more larger bundles, which may emit the light. In one or more embodiments of this aspect of the invention, there may be the same number of fiber endings in the input surface of smaller bundles as in the output surface of the larger bundle.

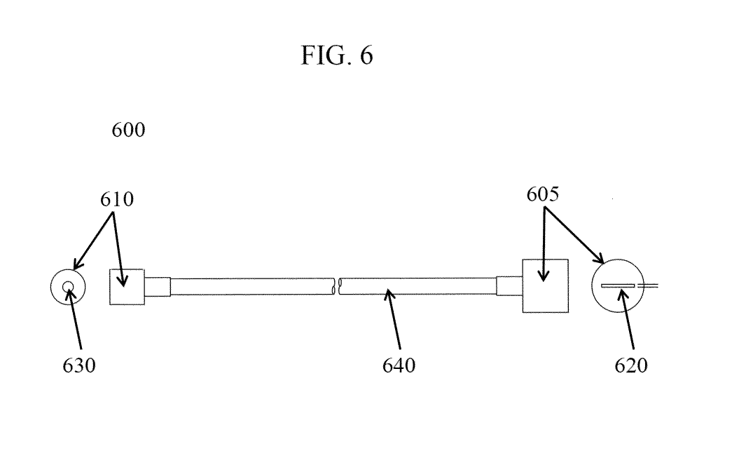

In one or more embodiments of the present invention, the bundle of optical fibers may be held together by a sheath and one or more end caps. Referring to FIG. 6, a fiber optic cable 600 used in accordance with an aspect of the present invention is shown. This can be the fiber 140 shown in FIG. 2. An end cap 605 may be operatively connected to the light-receiving end of the optical fiber bundle. In some embodiments, the end cap 605 comprises a slit 620 through which light may pass to be received by the optical fibers. The dimensions of the slit may have aspect ratios in the ranges of approximately 12:1 to 1:1, 8:1 to 1:1, 6:1 to 1:1, among others. In one or more embodiments, the aspect ratio will be reflective of the divergence of the light from the laser diode. In some embodiments, 38 degrees to 7 degrees which corresponds to an aspect ratio of approximately 5.42:1. The slit 620 is generally rectangular-shaped. In some embodiments, the cap 605 may be connected to a sheath 640 which covers the bundle of optical fibers. In some embodiments, the emitting end of the bundle of optical fibers may be operatively connected to a cap 610 that may comprise an aperture 630. The size and shape of the cap 610 and aperture 630 may be adapted to the desired shape of the output surface of the bundle of optical fibers. The shape of the aperture 630 is generally different than the shape of the slit 620. In FIG. 6 a circular aperture 630 is shown. One or more embodiments of the invention may comprise any of the input cap 605 and slit 620, sheath 640, or cap 610 and aperture, being used together or independently. In some embodiments, the bundle of fiber optic fibers are held together on one or more ends by an adhesive.

An input surface 150 may be formed by the input endings 155 of the optical fibers in the bundle, with the input endings having a position in the input surface defined by a first set of coordinates. Similarly, an output surface 160 may be formed by the output endings of the optical fibers, the output endings of the optical fibers having a position in the output surface defined by a second set of coordinates. In one or more embodiments, the input and output surfaces may be formed by aligning the ends of the optical fibers beside one another such that the ends of each fiber are in a single plane. In other embodiments, the ends of each fiber may be slightly staggered above and below a relative single plane. The set of coordinates defining the position of the ends of the optical fibers in the input or output surface may be two or three dimensional, and may be relative to two or more ends of the optical fibers or some arbitrarily selected points.

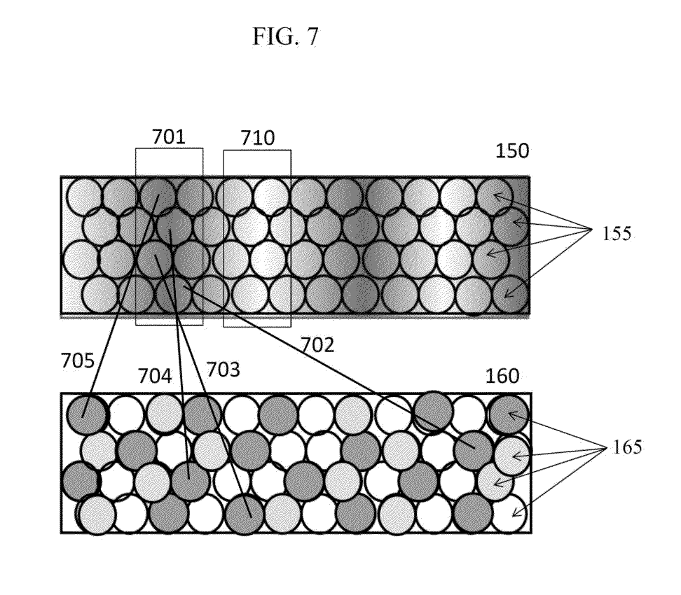

FIG. 7 shows a front view of the input surface 150 formed by input endings 155 of a bundle of optical fibers 140 according to one embodiment of the invention. FIG. 7 also shows a front view of an output surface 160 formed by output endings 165 of a bundle of optical fibers 140 according to one embodiment of the invention. As seen in FIG. 7, the input endings 155 of the optical fibers 140 have a position in the input surface 150 that is defined by a first set of coordinates in a first coordinate system. The output endings 165 of the optical fibers 140 have a position in the output surface 160 that is defined by a second set of coordinates in a second coordinate system 220. As discussed in detail below, the second set of coordinates are a non-affine transformation of the first set of coordinates. The non-affine transformation may be a result of random scrambling of the output endings 165 in the second coordinate system 220 while holding the input endings 155 fixed in the first coordinate system 210.

The organization of the input endings of the optical fibers relative to one another defined by the first set of coordinates may have a random order of positions, one or more repeated unit patterns position, or a combination of repeated unit patterns and random stacking positions. For example, the types of uniform packing may include one or more of the following patterns: triangular, trihexagonal, square, elongated triangular, hexagonal, truncated square, truncated trihexagonal, truncated hexagonal, snub square, rhombitrihexagonal, snub hexagonal, mirrored snub hexagonal, among others. Furthermore, in some embodiments where the diameter of the optical fiber varies, the arrangement of the input endings relative to one another may be defined by the first set of coordinates as having various types of regular or irregular arrangement. Similarly, the arrangement of the output endings relative to one another defined by the second set of coordinates may, in one or more embodiments, have a random order of positions, one or more repeated unit patterns position, or a combination of repeated unit patterns and random stacking positions.

One purpose of the optical bundle scrambler in accordance with an aspect of the present invention is to homogenize a non-uniform intensity pattern that is generated by a laser source to output more uniform spatial radiation to illuminate an object of which an image will be taken by a camera. Several types of laser diodes are relatively common and inexpensive, but have characteristics which make them unsuitable for use with high definition image capture. For example, laser diodes are known to emit light in a long and short axis such that the shape of the emitted light is extremely long and narrow. Some laser diodes emit light at angles of 38 degrees in the fast axis and 7 degrees in the slow axis, which corresponds to an aspect ratio of approximately 5.42:1. Such long and narrow beams are, even with a uniform radiation profile, not well suited for illuminating an object, where a beam at for instance 10 meters distance from the source should illuminate a circular area with a radius of at least 5 meters.

Furthermore, it is well known that multimode laser diode light sources emit light with non-uniform intensity patterns. In some embodiments of the present invention, the laser source outputs radiation with a multi-peaked spatial radiation intensity profile. In one embodiment of the present invention, an intensity difference between the peaks and troughs of a spatial radiation profile of a laser source is at least 5% of maximum relative intensity, or in another embodiment of the present invention at least 10% of maximum relative intensity, or in another embodiment of the present invention at least 20% of maximum relative intensity, or in another embodiment of the present invention at least 30% of maximum relative intensity, or in another embodiment of the present invention at least 40% of maximum relative intensity. In some embodiments, the intensity of the multi-mode laser diode may vary across a beam profile in the following manner: a peak relative intensity of 100% may drop to 75% at an adjacent trough of intensity, which then increases to 90% of relative intensity that drops to 68% at an adjacent trough, which then increases to 80% of relative intensity that drops to 50%, which then increases to 77% relative intensity that drops to 45%, which then increases to 62% relative intensity that drops to 30%. See, e.g., graph 1300 of FIG. 10. These intensity differences are noticeable and undesirable for illumination of an object of which an image is taken by a camera or is viewed on a display. Clearly, there is a need for an apparatus that makes the radiation pattern of the laser diode source more uniform with respect to intensity distribution and shape.

To overcome the deficiencies of laser diodes as light sources, one or more embodiments of the present invention utilizes a non-affine transformation of the endings of the optical fibers that receive and emit the light. Thus, the position of the output endings of the fibers relative to the input endings of the fibers are not maintained; instead they are changed.

An optical fiber bundle scrambler is provided in accordance with an aspect of the present invention that redistributes or scrambles or transforms a significantly non-uniform intensity radiation pattern into substantially uniform intensity radiation pattern. In one or more embodiments, an optical fiber bundle scrambler receives perceivably non-uniform intensity light from a laser diode source and outputs perceivably uniform light by redistributing the intensity pattern. The perception by which the light is judged to be uniform or non-uniform may be through an image sensing machine, a high definition camera, or the human eye. Furthermore, in addition to making light perceptibly more uniform, the optical fiber bundle scrambler also takes in a distribution of diverging light that is substantially broad and narrow and redistributes it to a different aspect ratio. Thus, the present invention overcomes the two major deficiencies of using multi-mode laser diodes as light sources for applications that require light of substantially uniform shape and intensity, such as high definition image capture.

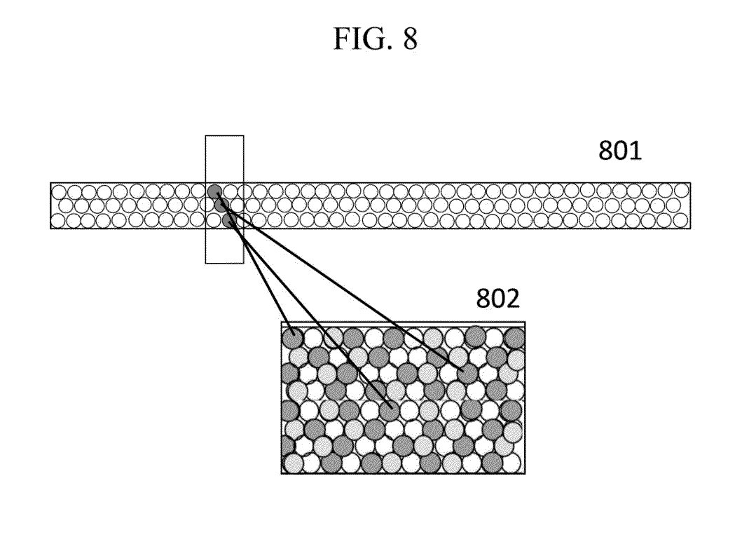

In accordance with an aspect of the present invention, the optical fibers between the input surface and output surface are arranged to make intensity input patterns that can be described or identified by variations in intensity at the input surface of the bundle to have disappeared or redistributed at the output surface of the fiber bundle. This change is illustrated in FIGS. 7 and 8. The fiber bundle has an input surface 150 with input area of fibers in a first arrangement. The fiber inputs may be provided coordinates, for instance relative to a corner of the input surface as rectangular coordinates. A hypothetical spatial intensity profile of the laser source has been overlaid on the diagram of 150 in FIG. 7 and one can see the darker areas and the lighter areas in the profile.

A dark band 701 has been identified in the profile and one can see that fiber input endings that fall within the dark band receive radiation with less intensity than in a band with higher intensity 710. The fibers are fixed, for instance with a cap, or an epoxy or glue, to be held in the input surface. The fibers in the bundle are then mixed, scrambled or distributed and fixed into an end surface with the output sides. This is shown as output surface 160 in FIG. 7 with a series of output endings of the optical fibers. The output endings forming the output surface 160 in FIG. 7 are shown as light or dark circles, indicating that the corresponding input endings forming the input surface 150 are in a light or darker band in the input surface. In order to eliminate, or at least diminish, the effect of dark/light bands or patterns when used to illuminate an object, the light pattern that exists at the input surface has to be broken up by re-arranging the fibers. This indicates that for instance a straight-through arrangement of fibers from input surface to output surface cannot be used. Other re-arrangements like mirroring or upside down arrangement also cannot be used, because the light patterns would re-appear at the output.

In accordance with an aspect of the current invention, the output endings of the fibers are arranged to have at each sub-surface in the output surface the same distribution of dark and light endings. A subsurface can be defined in many ways. For instance, it can be defined as a rectangle of for instance 1 mm×2 mm, but any useful size may be applied. The output surface is divided into contiguous square areas of 1 mm×2 mm or other sizes. The fibers are re-arranged so that each sub-surface in the output surface has the same or about the same number of light and darker fiber endings when the input surface is illuminated by the laser source with the undesirable spatial intensity pattern.

The sub-surface may also be defined as a square, rectangular, or round area in the output surface holding at least 9, 16, 25 or 49, or greater number, of output endings of fibers. One requirement is then that each sub-surface or region has a substantially equal distribution of light and darker fibers. Based on having equal distribution of light and darker fiber endings, each sub-surface in the output surface has the same average intensity. On a distance of 1 meter or more, the illumination pattern on an object or a wall from light radiated by the output surface will appear to be substantially uniform in intensity. In one embodiment, a laser light having multiple regions of peak and trough intensity in a defined area will be transformed into a substantially single-peaked intensity laser light in a defined area, with an approximately Gaussian distribution intensity variation symmetry around the center. For example, in some embodiments the transformed light will have an illumination pattern on an object or wall from the output surface with a substantially single peaked distribution that deviates less than 30% from Gaussian; less than 20% from Gaussian; less than 15% from Gaussian; or less than 10% from Gaussian.

There are different ways to describe the scrambling of fibers. One may describe it in terms of patterns that are provided on the input surface but that have disappeared in illuminating an object with the output surface of the scrambler below a certain intensity level. One may also define the mixing up of fibers in terms of coordinates of input endings in the input surface compared to coordinates of output endings in the output surface. A pattern of fiber ending in the input surface, as shown in FIG. 7, can be defined in terms of lines, which in this example are vertical lines. A requirement thus is that any mixing of fibers of which the input endings are arranged in a line or substantially a line, for instance between 1 and 5 or 1 and 10 or 1 and 20 fiber endings, cannot result in a line within a similar number of output endings on the output side. FIG. 7 illustrates this rearrangement of fibers. The ends of fibers 702, 703, 704, and 705 are substantially lined up at the input surface 150, but are not substantially lined up in the output surface 160.

The mixing of the fibers can be described as a 2D to 2D transformation of fiber ending positions from an input space (the input surface) to an output space (the output surface). Such a transformation can be a unique transformation that is not described by a formula, but for instance by a one-to-one transformation such as a translation of coordinates of positions of fiber endings. The transformation may also be a deliberate placement of fiber endings in some organization, rather than random. Whatever the transformation, such transformation is required to be non-affine. That is, three or more fiber endings with coordinates of positions being on a line or substantially on a line on the input surface are required to have output fiber endings that are NOT or substantially NOT on a single line on the output surface. “Substantially not on a single line” herein means within a range of fiber endings around a fiber ending. For instance within a range of 5, 10, 20 or more fiber endings.

The non-affine requirement is made somewhat easier by changing the aspect ratio of the output surface compared to the input surface. This is illustrated in FIG. 8. Fiber endings in a narrow area 801 can now be distributed over a greater vertical area because of the earlier stated additional requirement to change an aspect ratio of the output surface compared to the aspect ratio of the input surface.

In one or more embodiments of the invention, the scrambling of the fibers may be defined by the spatial intensity distribution of light emitted from the output surface. For example, in some embodiments, relative positioning of the fiber ends may be defined by the ability to receive light having a multi-peaked spatial intensity distribution across the envelope of light, and outputting a substantially single-peaked (approximating Gaussian) spatial intensity distribution across the envelope of light.

Adequate scrambling or mixing of fibers may be checked by illuminating the input surface with a radiating profile that has clear bands with sufficient intensity differentials and seeing if an output projection on a screen at 1 meter from the radiating output is sufficiently uniform. Another way is to illuminate the input surface with bands of different colors. If the output illumination shows sufficiently mixed colors with no clear color patches then the scrambling may be considered at least to be adequate.

Even if all fiber ending positions are transformed from input surface to output surface in a manner that is characterized as non-affine, there is still a chance that fiber positions transformed from different dark band areas in the input surface of the fiber bundle are arranged on a line or substantially a line on the output surface. The fiber bundle may contain hundreds, or close to a thousand, or over a thousand, or many thousands of optical fibers. In some embodiments, a 5 mm diameter bundle at the output surface contains over 8,500 fibers. In other embodiments, an 8 mm diameter bundle at the output surface contains over 21,500 fibers. The occurrence of a small number of dark or darker fiber output endings positions on a line will not noticeably affect a uniformity of an illumination of an object of at least 1 meter distance of the output surface, especially if the light intensity distribution of contiguous sub-regions such as 5 by 5 fiber endings regions contains approximately the same number of dark and light fibers. In accordance with an aspect of the present invention, preferably more than 50% of the fibers in the bundle are mixed in a non-affine manner, more preferably more than 75% of the fibers in the bundle are mixed in a non-affine manner, and most preferably more than 90% of the fibers in the bundle are mixed in a non-affine manner.

The optical scrambler receives the light with the multi-peaked intensity pattern from the laser at the input surface and radiates light from the output surface that has a more uniform intensity profile. In one or more embodiments, the input surface is dimensioned rectangularly to substantially match the divergence of the light emitted from the light source. These dimensions may have an aspect ratio of in the range of approximately 12:1 to 2:1. In some embodiments, the input surface is dimensioned rectangularly to substantially match the divergence of light from a laser diode with a fast axis of 38 degrees and a slow axis of 7 degrees, which corresponds to an aspect ration of approximately 5.43:1. In other embodiments, the aspect ratio of the rectangular input surface may be greater than 12:1 or less than 2:1. In other embodiments the input surface may be oval shaped to substantially match the divergence of the light emitted from the light source. The total length and width of the oval shaped input surface may have an aspect ratio of in the range of approximately 12:1 to 2:1 across its perpendicular axes. In other embodiments the aspect ratio of the oval shaped input surface may be greater than 12:1 or less than 2:1.

In one or more embodiments, the input surface may be positioned at a distance between approximately less than 1 mm to 20 mm from the radiating facet of the light source. In other embodiments, the input surface is positioned at a distance of approximately 4 mm from the radiating facet of the light source. In some embodiments, the input surface is positioned to be substantially parallel with the radiating facet of the light source, while in other embodiments the input surface is angled relative to the fast axis or slow axis of the radiating light. In some embodiments, the input surface is operatively connected to a cap having a slit or aperture.

FIGS. 9 through 11 illustrate the intensity distribution of light received by the input surface from the laser diode and light emitted from the output surface, according to one or more embodiments of the present invention. The data of FIGS. 9 through 11 was obtained using a DataRay WinCamD optical beam profiler. The measurement of the raw light was taken at a distance of approximately 4 mm from the radiating facet of the laser diode. Unless otherwise specified, the measurement of light emitted from one or more embodiments of the present invention was taken at a distance of approximately 4 mm from the output surface. The WinCamD Series User Manual published by DataRay Inc., Rev. 1207a, available at http://www.dataray.com/wincamd-lcm-beam-profiling-camera.html#tabs-5, and which is incorporated herein by references in its entirety, shows several ways of describing the captured data.

FIG. 9 represents a two dimensional profile of light according to one embodiment of the present invention after being emitted from the laser diode, seen in 1100, and after being emitted from one embodiment of the output surface, seen in 1101. It is apparent in FIG. 9 that when light from the laser diode is projected onto an object (in this case the object is the beam profiler), the light has several prominent regions of spatial intensity, the local maxima of which are located at, for example, 1107. Only a few of the local maxima of these regions of intensity are marked as 1107 for illustrative purposes. These spatial variations in intensity of light are further represented in graph 1120. The various local maxima 1107 of light intensity along first axis 1106 are apparent in graph 1120. Similarly, various local minima 1104 of light intensity along first axis 1106 are apparent in graph 1120. Only three exemplary local maxima are marked as 1107, and three exemplary local minima are marked as 1104. As seen in graph 1120, the difference in intensity between a local maxima and an adjacent local minima may be as much as 40% of the maximum relative intensity. In the beam profile depicted in 1120, those variations in intensity occur over a distance of less than one-sixth (⅙) of the diameter of the beam along 1106. Put another way, the shape of the line representing the distribution of light along axis 1106 is substantially jagged. Put yet another way, light projected on object may vary in intensity across that object such that the intensity does not continuously increase or continuously decrease across it. Thus, it is apparent from the profile along first axis 1106 that light projected on an object from the laser diode may have multiple local regions of high intensity adjacent to local regions of substantially weaker intensity, making this light source unacceptable for illumination with high resolution image capture.

As seen in graph 1121, the distribution of light intensity across axis 1105 is more uniform than across 1106. However, an uneven light intensity distribution as measured across a single axis of the laser diode beam may make it unsuitable for illumination with high resolution image capture.

Graph 1300 in FIG. 10 shows another measurement of the intensity distribution of light emitted from the multi-mode laser diode. This particular measurement was taken at a distance of greater than 4 mm to expand the proportions of the beam to further illustrate variations in intensity. This measurement shows the intensity of the multi-mode laser diode varying across the beam profile in the following manner: a peak relative intensity of 100% may drop to 75% at an adjacent trough of intensity, which then increases to 90% of relative intensity that drops to 68% at an adjacent trough, which then increases to 80% of relative intensity that drops to 50%, which then increases to 77% relative intensity that drops to 45%, which then increases to 62% relative intensity that drops to 30%. This uneven intensity distribution is clearly unsuitable for illumination with high resolution image capture.

FIG. 9 also represents a two dimensional profile 1101 of light after being emitted from one embodiment of the output surface of the present invention. It is apparent from 1101 that the light emitted from the output surface has a central region of highest intensity that diminishes regularly from its center. The central region with the most intense light is indicated at 1110. The spatial intensity distribution of light emitted from that output surface is also illustrated in graph 1130 and graph 1131. Graph 1130 represents the relative intensity of light along first axis 1109. Graph 1131 represents the relative intensity of light along second axis 1108. In contrast to the shape of the line representing the distribution of light intensity seen in 1120, the shape of the line seen in 1130 is much smoother. In fact, the beam profile depicted in 1130 has large regions with no minima or maxima because the intensity of light continuously increases or decreases. For example, as seen in 1130, in some places the light continuously increases or continuously decreases across a distance of more than one-seventh ( 1/7) of the diameter of the beam. Where adjacent local minima and maxima exist in 1130, the difference in intensity is less than approximately 10% of the maximum relative intensity. Furthermore, the same relatively smooth shape of the line is seen in 1131 representing light intensity along second axis 1108. Similar to 1130, in the few places where adjacent local minima and maxima exist in 1131 the difference in intensity is less than approximately 10% of the maximum relative intensity. Also similar to 1130, the beam profile depicted in 1131 has large regions with no minima or maxima because the intensity of light continuously increases or decreases. For example, as seen in 1131, in some places the light continuously increases or continuously decreases across a distance of more than one-seventh ( 1/7) of the diameter of the beam along 1108.

An alternative way to characterize the changes to the light received by the input surface compared with the light emitted by the output surface is to use a convex envelope determined by the smallest convex region around a portion of the beam profile curve that never crosses into the curve itself. FIG. 10 illustrates this alternative characterization for each of the beam profiles described above. As seen in graph 1120 of FIG. 10, a convex envelope 1210 has been overlaid on the beam profile curve. In this illustration, the convex envelope 1210 falls around the beam profile curve bounded at 13.5% of the highest beam intensity value 1205. It is, of course, possible to characterize the beam profile using a convex envelope bounded at any other fraction of the highest beam intensity value. It is apparent in 1120 that there is a significant difference in the area of the convex envelope 1210 when compared to the area of the beam profile curve 1201. This difference is seen, for example, as space 1207 that falls between the convex envelope 1210 and the beam profile curve 1201. The sum of all the space between a convex envelope and a beam profile curve is hereinafter referred to as the “convex envelope differential.”

FIG. 10 also illustrates the beam profile graph 1130 overlaid with a convex envelope 1230 bounded at 13.5% of the highest beam intensity value 1227. For beam profile graph 1130, the difference in the area of the convex envelope 1230 and the beam profile curve 1231 is not as great as the difference seen in graph 1120. This smaller difference is seen, for example, as space 1225 that falls between the convex envelope 1230 and the beam profile curve 1231.

Thus, it is apparent that the convex envelope differential for light emitted from the output surface of an embodiment of the present invention is smaller than the convex envelope differential for light emitted from the laser diode and received by the input surface. The ratio of the convex envelope differential for two curves (e.g. (output surface convex envelope differential)/(input surface convex envelope differential)) may be referred to as a “convex envelope differential ratio.” In one or more embodiment of the invention, the convex envelope differential ratio of output surface convex envelope differential/input surface convex envelope differential, as measured in one or more axes of the beam profile, is less than 0.8, less than 0.6, less than 0.3, or less than 0.1.

FIG. 10 also illustrates the beam profile graphs 1121 and 1131 overlaid with a convex envelope bounded at 13.5% of the highest beam intensity value. It is apparent that the convex envelope differential may change depending on which axis the beam profile data is collected from. Likewise, the convex envelope differential ratio may be different depending on which axis is used to collect the beam profile data. In one or more embodiments of the present invention, the convex envelope differential of light emitted from the output surface will be substantially the same as measured across two perpendicular axes of the emitted light. In one or more embodiments, the convex envelope differential ratio as measured across two perpendicular axes of light emitted from the output surface is greater than 0.95, greater than 0.85, greater than 0.75, or greater than 0.5.

One of the benefits of one or more embodiments of the present invention is that it is capable of changing the overall shape of the intensity distribution of light. One way of characterizing spatial changes to the intensity of light received by the input surface when compared to the light emitted from the output surface is to look to the shape of the emitted light using the relative width of the beam at a fixed fraction of light intensity. As an illustrative example, graph 1121 has been overlaid with a line indicating 50% of maximum light intensity 1240. The curve 1241 intersects line 1240 at points 1242. The width of the beam profile at that intersection is approximately 1,024 um and is indicated as the distance between drop down lines 1243. Graph 1121 has also been overlaid with a line indicating 13.5% of maximum light intensity 1244. The curve 1241 intersects with line 1244, having a width of the beam profile at that intersection of approximately 2,136 um, indicated by drop down lines 1245. Thus, it is apparent that the width of the intensity profile at 50% of maximum intensity is approximately half the width of the intensity profile at 13.5% of peak intensity.

Graph 1131 in FIG. 10 has also been overlaid with lines indicating 50% of maximum light intensity 1250, and lines indicating 13.5% of maximum light intensity 1251. The dropdown lines 1252 showing the width of the intensity profile at 50% and the dropdown lines 1253 showing the width of the intensity profile at 13.5% are also indicated. The width of the beam profile between dropdown lines 1252 is approximately 4,629 um, while the width of the intensity profile between dropdown lines 1253 is approximately 8,039 um.

By looking at the width of the beam profile at 50% of maximum intensity, or 13.5% of maximum intensity, it is apparent that the beam intensity profile of light emitted from the output surface of an embodiment of the present invention (depicted, for example, in 1131) is broader along one or more axes than the beam intensity profile along one or more axes received by the input surface (depicted, for example, in 1121). For example, as seen in graph 1121 at 50% of maximum intensity 1240 along axis 1105, the width of the light intensity profile 1243 received by the input surface is less than one-quarter of the width of the light intensity profile 1252 emitted from the output surface along axis 1108 in graph 1131. This relationship between the breadth of the light intensity distribution profile received by the input surface and emitted by the output surface is hereby referred to as the “50% maximum intensity ratio.” Thus, in the exemplary embodiment illustrated in graphs 1121 and 1131, the 50% maximum intensity ratio between the light received by the input surface compared to light emitted from the output surface is less than 0.5. In alternative embodiments of the present invention, the 50% maximum intensity ratio along one or more axis may be less than 0.8, less than 0.6, less than 0.3, or less than 0.1.

An alternative description of this relationship may be that the width of the beam profile curve at 50% maximum relative intensity, indicated by dropdown lines 1252, along at least one axis crossing the midpoint of the bean profile of light from the output surface, is greater than the width of the beam profile curve at 50% maximum relative intensity, indicated e.g. by dropdown lines 1243, along at least one axis crossing the midpoint of the beam profile of light from the multimode laser diode. In one or more embodiments, the width of the beam profile curve at 50% maximum relative intensity, along a first axis crossing the midpoint of the beam profile of light from the output surface, is at least 190% greater than the width of the beam profile curve at 50% maximum relative intensity, along a first axis crossing the midpoint of the beam profile, of light from the multimode laser diode. Furthermore, some embodiments may have a width of the beam profile curve at 50% maximum relative intensity along a second axis crossing the midpoint of the beam profile of light from the output surface, is at least 400% greater than the width of the beam profile curve at 50% maximum relative intensity along a second axis crossing the midpoint of the beam profile of light from the multi-mode laser diode.

Similarly, at 13.5% of maximum intensity along axis 1105, the width of the light intensity profile 1245 received by the input surface is less than one-third of the width of the light intensity profile 1253 emitted from the output surface along axis 1108. This relationship between the breadth of the light intensity distribution profile received by the input surface and emitted by the output surface is hereby referred to as the “13.5% maximum intensity ratio.” Thus, in the exemplary embodiment illustrated in graphs 1121 and 1131, the 13.5% maximum intensity ratio between the light received by the input surface compared to light emitted from the output surface is less than about 0.33. In alternative embodiments of the present invention, the 13.5% maximum intensity ratio along one or more axis may be less than 0.8, less than 0.6, less than 0.3, or less than 0.1.

Alternatively, the breadth of the beam intensity profile can be characterized by looking to the 50% or 13.5% maximum intensity ratio across two perpendicular axes of a single beam. For example, the maximum intensity ratio across two perpendicular axes of light emitted from the output surface. As seen in graph 1130 along axis 1109, the width of the beam profile at 50% maximum intensity 1232 is approximately 5,280 um, as indicated by dropdown lines 1233. By comparison, as seen in graph 1131 along axis 1108, the width of the beam profile at 50% maximum intensity 1250 is approximately 4,629 um, as indicated by dropdown lines 1252. Thus, in this exemplary embodiment, the ratio: (width at 50% maximum intensity along 1108)/(width at 50% maximum intensity along 1109) is greater than 0.85. In one or more embodiments, the 50% maximum intensity ratio across two perpendicular axes may be greater than 0.6, greater than, 0.7, greater than 0.8, or greater than 0.9. Similarly, in one or more embodiments, the 13.5% maximum intensity ratio across two perpendicular axes may be greater than 0.6, greater than, 0.7, greater than 0.8, or greater than 0.9.

By contrast, the 50% maximum intensity ratio across two perpendicular axes of light received by the input surface may have a substantially different value. As seen in graph 1120 along axis 1106, the width of the beam profile at 50% maximum intensity 1211 is approximately 2,664 um, as indicated by dropdown lines 1212. As seen in graph 1121 along axis 1105, the width of the beam profile at 50% maximum intensity 1240 is approximately 1024 um, as indicated by dropdown line 1243. Thus, in this exemplary embodiment, the ratio: (width at 50% maximum intensity along 1105)/(width at 50% maximum intensity along 1106) is less than 0.4. In one or more embodiments the 50% maximum intensity ratio across two perpendicular axes may be less than 0.6, less than 0.5, less than 0.4 or less than 0.3. Similarly, in one or more embodiments the 13.5% maximum intensity ratio across two perpendicular axes may be less than 0.6, less than 0.5, less than 0.4 or less than 0.3.

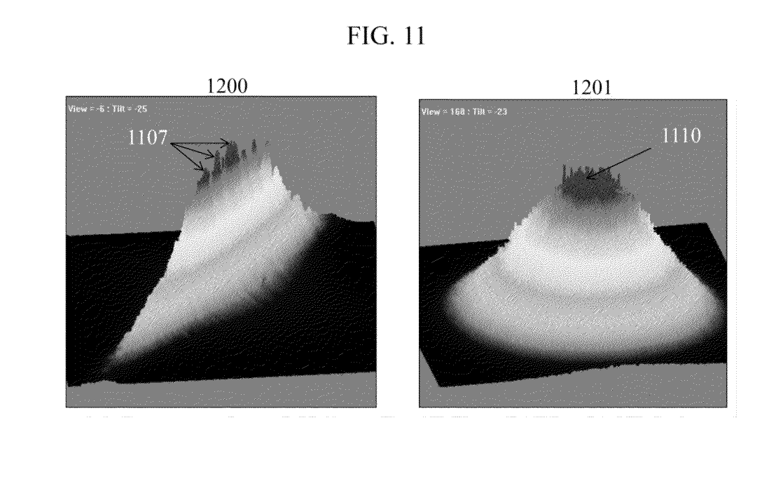

FIG. 11 provides a three-dimensional illustration of light emitted from the laser diode and thus received by the input surface (1200), and an illustration of light emitted from the output surface of an embodiment of the present invention (1201). The three exemplary local maxima 1107 are readily apparent in this view of the beam profile. By contrast the central region 1110 with the most intense light is readily apparent for the three-dimensional representation of light emitted from the output surface 1201.

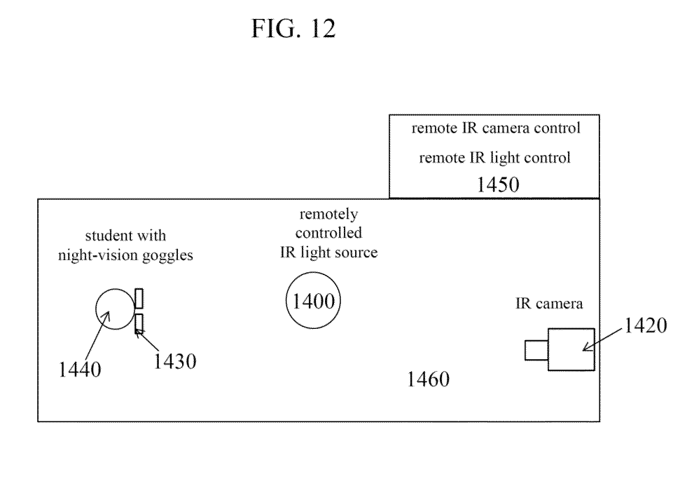

FIG. 12 provides an illustration of an aspect of the present invention used for training to work with a night vision apparatus, camera, and goggles. The illuminator 1400 can be activated and controlled separate from the camera 1420 or goggles 1430 worn by a student 1440. The illuminator 1400 may be an IR illuminator, which are known, and the IR light source 1400 goggles 1430 and camera 1420 may be in separate housings. The goggles 1430, camera 1420, and light source 1400 may be located at a distance from one another of greater than 1 meter, 3 meters, 5 meters, or more. The light source 1400 may be independently activated or deactivated by a training supervisor from a remote area 1450. Thus, it is apparent in this aspect of the invention the benefit of having a uniform distribution of light emitted from the light source 1400 so that objects around the training room are evenly illuminated. Furthermore, while IR lasers are commonly used as target pointers and therefore require a narrow beam, the IR light source in various aspects of the present invention are used to illuminate a room, and therefore may employ a wider beam. For example in one or more embodiments, the light source 1400 may diverge with the approximate shape of a right cone having an opening angle of approximately 90 degrees.

It is important to note that the graphical representations in FIGS. 9 to 11 illustrating the intensity distribution of light emitted from the output surface do not correspond to any particular organization of fibers. For example, as seen in image 1101 and 1201, the concentric circles of diminishing light intensity away from region 1110 do NOT indicate a similar pattern of light being emitted from optical fibers in the output surface of the present invention. To the contrary, one or more embodiments of the output surface emit light that is, on average, substantially uniform between any given areas. The concentric circles of diminishing light intensity away from 1110 seen in the figures is merely the result of diversion and diffusion of homogenous light after being emitted from the output surface. That being said, FIGS. 9 to 11 illustrate a uniform intensity distribution of homogenized light after being projected onto an object from the output surface, which is useful for high definition capture of images.

While the invention has heretofore been described with certain degrees of particularity, there are countless configurations for the present invention. FIGS. 1 through 11 illustrate only a few possible configurations, and in no way should be construed as limiting the application of the inventive apparatus to those configurations. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A light source, comprising:
a multi-mode laser diode having a radiating facet, the facet radiating light that diverges with a first beam intensity profile having a first shape;
a bundle of optical fibers having:
an input surface formed by input endings of the optical fibers in the bundle; and
an output surface formed by output endings of the optical fibers in the bundle;
wherein the input surface of the bundle of optical fibers receives the light, and the output surface of the bundle of optical fibers emits the light;
wherein the light emitted from the output surface diverges with a second beam intensity profile having a second shape, the second shape being different from the first shape;
wherein the input endings have a position defined by a first set of coordinates relative to the input surface, and the output endings have a position defined by a second set of coordinates relative to the output surface;
wherein a plurality of the output endings are mixed in the output surface in a non-affine manner relative to the input endings in the input surface.

2. The light source of claim 1, wherein the intensity of the beam profile of light from the multi-mode laser diode is asymmetric around the midpoint of the beam profile; and
wherein the beam profile of light from the output surface is substantially symmetric around the midpoint of the beam profile.

3. The light source of claim 2, wherein the width of the beam profile curve, at 50% maximum relative intensity, along a first axis crossing the midpoint of the beam profile of light from the output surface, is at least 190% greater than the width of the beam profile curve, at 50% maximum relative intensity, along a first axis crossing the midpoint of the beam profile, of light from the multi-mode laser diode.

4. The light source of claim 3, wherein the width of the beam profile curve, at 50% maximum relative intensity, along a second axis crossing the midpoint of the beam profile of light from the output surface, is at least 400% greater than the width of the beam profile curve, at 50% maximum relative intensity, along a second axis crossing the midpoint of the beam profile, of light from the multi-mode laser diode.

5. The light source of claim 1, wherein the first beam intensity profile has a curve along a first axis crossing the midpoint of the beam intensity profile, the curve bounded at 13.5% maximum light intensity, with a convex envelope differential having a first value;
wherein the second beam intensity profile has a curve along a second axis crossing the midpoint of the beam intensity profile, the curve bounded at 13.5% maximum light intensity, with a convex envelope differential having a second value;
wherein the ratio of the first value to the second value is in the range of approximately 0.1 to 0.8.

6. The light source of claim 1, wherein one or more of the optical fibers in the bundle are divided into two or more branches.

7. The light source of claim 1, wherein the laser emits light with an infrared wavelength.

8. The light source of claim 1, wherein the first beam profile has a non-circular shape and the second beam profile has a circular shape.

9. The light source of claim 1, further comprising a housing which encloses the laser and the optical scrambler, the housing comprising an output aperture at the output surface.

10. The light source of claim 9, further comprising:
a second housing which encloses a power supply electrically coupled to a laser driver;
wherein the laser driver has an output coupled to the multi-mode laser to provide power to the multimode laser.

11. The light source of claim 9 wherein an object is illuminated by light from output surface, further comprising:
a camera enabled to produce an image of the object; and
a display connected to the camera to display the image produced by the camera of the object.

12. The light source of claim 11, wherein the camera is capable of recording light within a spectrum range from ultraviolet to infrared.

13. The light source of claim 11, further comprising an ambient light sensor connected to a circuit that cuts off power to the multi-mode laser when ambient light is present.

14. The light source of claim 13, the camera further comprising a light filter that is switched in when the amount of visible ambient light is above a pre-determined threshold set by a user and switched out when the amount of visible ambient light is below the pre-determined threshold set by the user.

15. The light source of claim 11, wherein the display is goggles that can be worn.

16. A method for producing an image of an object with a camera, comprising:
a multi-mode laser diode emitting light with a first beam intensity profile having a first shape;
an input surface of a bundle of optical fibers receiving the light with the first beam profile having a first shape;
the bundle of optical fibers transmitting the light to an output surface that arranges the optical fibers in a second arrangement;
illuminating the object with the light from the output surface, the light from the output surface having a second beam intensity profile with a second shape, the second shape being different from the first shape; and
producing an image using the light having the second beam profile with the second shape, received by the camera.

17. The method of claim 16, wherein the light emitted from the laser diode is infrared.

18. The method of claim 16, wherein the input endings of the optical fibers have a position in the input surface defined by a first set of coordinates, and the output endings of the optical fibers have a position in the output surface defined by a second set of coordinates, the second set of coordinates being a non-affine transformation of the first set of coordinates.

19. The method of claim 16, wherein the intensity of the beam profile of light from the multi-mode laser diode is asymmetric around the midpoint of the beam profile; and
wherein the beam profile of light from the output surface is substantially symmetric around the midpoint of the beam profile.

20. The method of claim 19, wherein the width of the beam profile curve, at 50% maximum relative intensity, along a first axis crossing the midpoint of the beam profile of light from the output surface, is at least 190% greater than the width of the beam profile curve, at 50% maximum relative intensity, along a first axis crossing the midpoint of the beam profile, of light from the multi-mode laser diode.

21. The method of claim 20, wherein the width of the beam profile curve, at 50% maximum relative intensity, along a second axis crossing the midpoint of the beam profile of light from the output surface, is at least 400% greater than the width of the beam profile curve, at 50% maximum relative intensity, along a second axis crossing the midpoint of the beam profile, of light from the multi-mode laser diode.

22. The method of claim 16, wherein the first beam intensity profile has a curve along a first axis crossing the midpoint of the beam intensity profile, the curve bounded at 13.5% maximum light intensity, with a convex envelope differential having a first value;
wherein the second beam intensity profile has a curve along a second axis crossing the midpoint of the beam intensity profile, the curve bounded at 13.5% maximum light intensity, with a convex envelope differential having a second value;
wherein the ratio of the first value to the second value is in the range of approximately 0.1 to 0.8.

23. The method of claim 16, wherein the produced image has a resolution of 1920×1080p or higher.
